(19) United States
(12) Patent Application Publication
(10) Pub. No.: US 2012/0151102 A1
(43) Pub. Date: Jun. 14, 2012

(54) COMPUTER SYSTEM, CONNECTION CONTROLLER, AND METHOD FOR CONNECTION CONTROLLER

(75) Inventors: HUA-DONG CHENG, Shenzhen City (CN); XIN ZHAO, Shenzhen City (CN); CHIH-SAN CHIANG, Tu-Cheng (TW); HAN-CHE WANG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/095,875

(22) Filed: Apr. 28, 2011

(30) Foreign Application Priority Data
Dec. 14, 2010 (CN) 201010586962.1

(51) Int. Cl. G06F 3/00

(52) U.S. Cl. 710/19

(57) ABSTRACT

A connection controller and connection control method for controlling the connections of a peripheral device with a computer is provided. The connection controller can detect the connection status of the peripheral devices and initializes the peripheral device while the peripheral device is connected. The connection controller transmits an interrupt signal to the computer while the peripheral device is initialized to allow the computer to access the peripheral device. Alternatively, the connection controller generates a suspend signal to switch off the power supply track from the computer to the peripheral device, and the connection controller will then be suspended without unloading the driver of the peripheral device to eliminate the repetition of loading and unloading the driver of the peripheral device.

### BACKGROUND

1. Technical Field

The present disclosure relates to a connection controller, and particularly, to a connection controller controlling the connections between a peripheral device and a computer.

2. Description of the Related Art

Computers use computer interfaces to communicate with peripheral devices, and USB (Universal Serial Bus) is one of the most popular interfaces for personal computers. USB peripheral devices can be automatically configured while connected to a computer, and are hot pluggable to be connected or disconnected without restarting the computer. The computer automatically loads the driver of the peripheral device when the peripheral device is connected, and unloads the driver when the peripheral device is disconnected. However, if multiple connections and disconnections are performed in a short period of time, loading and unloading the driver will be time-consuming and problematic for users.

Therefore, what is needed is a connection controller and a connection control method to eliminate the time-consuming repetition of loading and unloading the drivers of the peripheral devices.

### BRIEF DESCRIPTION OF THE DRAWINGS

The components in the drawings are not necessarily drawn to scale, the emphasis instead being placed upon clearly illustrating the principles of connection controllers. Moreover, in the drawings, like reference numerals designate corresponding parts throughout the several views.

FIG. 1 is a system block diagram of a connection controller coupled between a computer and a peripheral device in accordance with an exemplary embodiment.

FIG. 2 is a flowchart of a connection and disconnection method in accordance with an exemplary embodiment.

### DETAILED DESCRIPTION

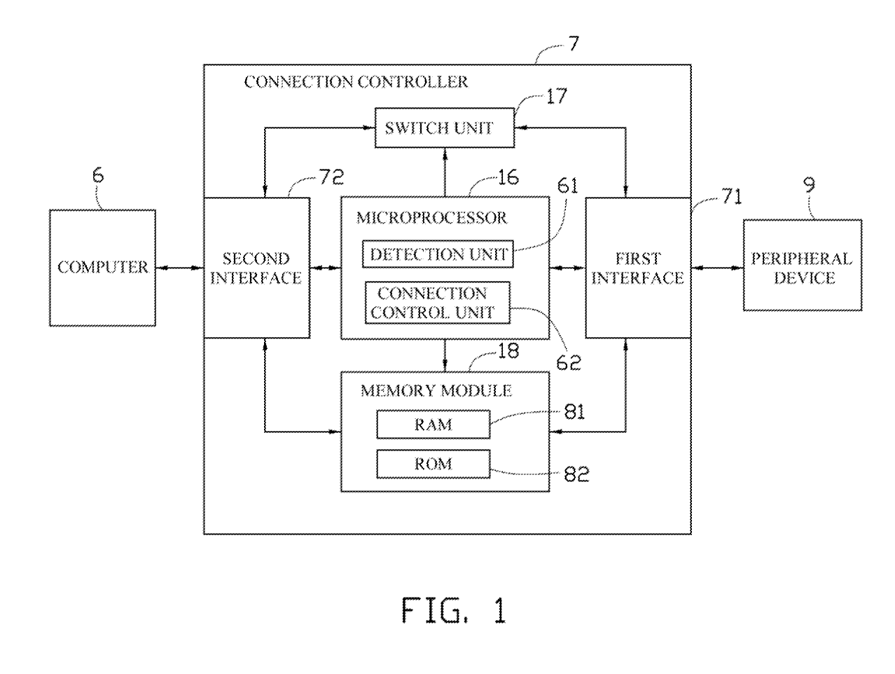

Referring to FIG. 1, a connection controller 7 coupled to a computer 6 is capable of connecting with a peripheral device 9 to allow communications between the computer 6 and the peripheral device 9. The connection controller 7 includes a first interface 71 coupled with the computer 6, a second interface 72 capable of connecting with peripheral device 9, a microprocessor 16 having a detection unit 61 and a connection control unit 62 therein, a switch unit 17, and a memory module 18 having a Random Access Memory (RAM) 81 for data buffering and a Read-Only Memory (ROM) 82 for storing configuration data of the connection controller 7.

The detection unit 61 can detect the connection status between the first interface 71 and the peripheral device 9 to determine whether the peripheral device 9 is connected to the connection controller 7 or not. The connection control unit 62 generates a connection signal while the peripheral device 9 is connected to the first interface 71. While receiving the connection signal, the microprocessor 16 initiates the peripheral device 9 and transmits an interrupt signal to the computer 6. The computer 6 loads a driver of the peripheral device 9, and accesses the peripheral device 9 in response to the interrupt signal. Data requested by the computer 6 are transmitted from the peripheral device 9 to the RAM 81, and temporally stored therein before transmitting to the computer 6.

The connection control unit 62 generates a suspend signal while the peripheral device 9 is disconnected from the first interface 71. While receiving the suspend signal, the connection controller 7 is suspended by the microprocessor 16 until peripheral device 9 is reconnected to the first interface 71.

The switch unit 17 switches on a power supply track from the computer 6 to the peripheral device 9 in response to the connection signal to power the peripheral device 9, and switches off the power supply track in response to the suspend signal.

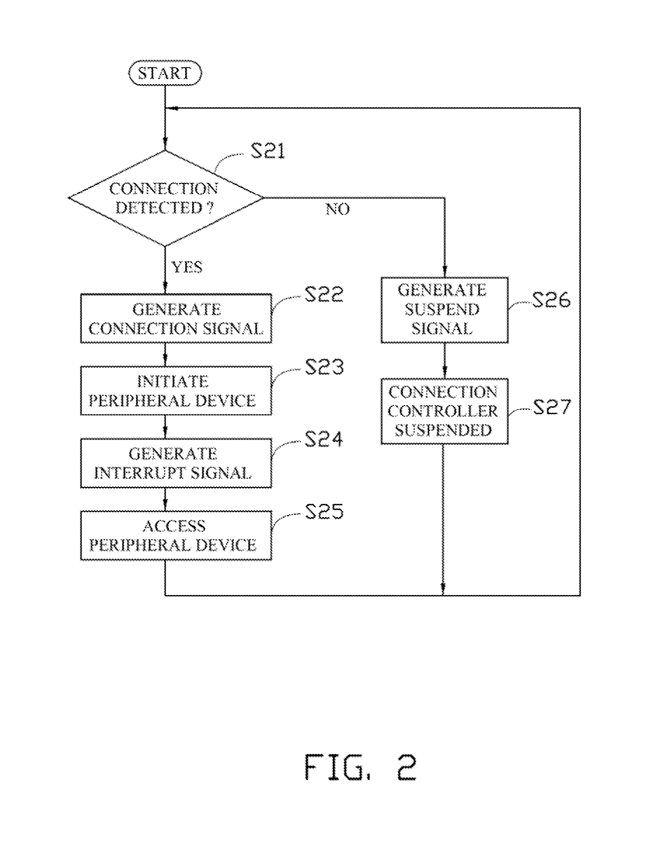

Referring to FIG. 2, a flowchart of a connection and disconnection method is illustrated. In step 21, the detection unit 61 detects the connection status between the peripheral device 9 and the connection controller 7.

In step 22, if the peripheral device 9 is connected, the connection control unit 62 generates the connection signal.

In step 23, upon receiving the connection signal, the microprocessor 16 initiates the peripheral device 9.

In step 24, the microprocessor 16 generates an interrupt signal while the peripheral device 9 is initiated.

In step 25, after receiving the interrupt signal, the computer 6 can request data form the peripheral device 9. The data corresponding to the request is transmitted from the peripheral device 9 to the RAM 81 and temporally stored in the RAM 81 before transmission to the computer 6. The detection unit 61 continues to detect the connection status while the computer 6 is communicating with the peripheral device 9.

In step 26, if the peripheral device 9 is connected, the connection control unit 62 generates the suspend signal.

In step 27, the microprocessor 16 suspend the connection controller 7 in response to the suspend signal. The detection unit 61 continues to detect the connection status while the connection controller 7 is suspended.

Therefore, when the connection controller 7 is connected with the computer 6, the connection status between the peripheral device 9 and the connection controller 7 will not incur the repetitive loading and unloading of the driver saving the user's time and the processing resources of the computer 6.

1. A connection controller to control the connection between a peripheral device and a computer, comprising:
a first interface for coupling the peripheral device;
a second interface for coupling the computer;
a microprocessor for initiating the peripheral device or suspending the connection controller, wherein the microprocessor comprising a detection unit to detect the connection status between the peripheral device and the first interface; the microprocessor further includes a connection control unit coupled to the detection unit, and the connection control unit is to receive a connection signal or a suspend signal generated by the detection unit; and
wherein the computer loads a driver of the peripheral device when the connection signal is received by the microprocessor, and the connection status between the peripheral device and the first interface will not incur repetitive loading and unloading of the driver when the connection controller is connected with the computer.

2. The connection controller as claimed in claim 1, wherein the connection signal is generated when the peripheral device is connected, and the microprocessor initiates the peripheral device in response to the connection signal.

3. The connection controller as claimed in claim 1, wherein the suspend signal is generated when the peripheral device is disconnected, and the microprocessor suspends the connection controller in response to the suspend signal.

4. The connection controller as claimed in claim 1, wherein the connection controller further comprises a switch unit controlling a power supply track from the computer to the peripheral device; the switch unit switches on the power supply track when the peripheral device is connected and switches off when the peripheral device is disconnected.

5. The connection controller as claimed in claim 1, wherein the connection controller further comprises a memory module having a Random Access Memory (RAM) for data buffering and a Read-Only Memory (ROM) for storing configuration data of the connection controller.

6. A connection control method for controlling connection and disconnection between a peripheral device and a computer, comprising:
detecting the connection status between the peripheral device and a connection controller coupled to the computer;
generating a suspend signal if the peripheral device is disconnected;
switching off the power supply track from the peripheral device to the computer;
suspending the connection controller;
detecting the connection status between the peripheral device and the connection controller while the connection controller is suspended; and
wherein the computer loads a driver of the peripheral device when the peripheral device is connected with the connection controller, and the driver is not unloaded when the connection controller is suspended.

7. The method as claimed in claim 6, further comprising:
generating a connection signal if the peripheral device is connected;
switching on the power supply track from the peripheral device to the computer; and
initiating the peripheral device.

8. The method as claimed in claim 7, further comprising:
generating an interrupt signal to the computer upon the peripheral device being initiated;
requesting data from the peripheral device;
buffering the data in a memory module of the connection controller;
reading the data in the memory module; and
detecting the connection status between the peripheral device and the connection controller while the computer is accessing the peripheral device.
